(19) United States
(12) Patent Application Publication
(10) Pub. No.: US 2006/0123678 A1
(43) Pub. Date: Jun. 15, 2006

(54) Illuminated indicia

(76) Inventor: Hossein Arvin, Vancouver (CA)

Correspondence Address: MILES & STOCKBRIDGE PC, 1751 PINNACLE DRIVE, SUITE 500, MCLEAN, VA, 22102-3833, US

(21) Appl. No.: 10/534,352

(22) PCT Filed: Oct. 24, 2003
(86) PCT No.: PCT/CA03/01623

§ 371 Date: Nov. 30, 2005

(30) Foreign Application Priority Data
Nov. 8, 2002 (CA) 2411422

(51) Int. Cl. G09F 13/00

(52) U.S. Cl. 40/547

(57) ABSTRACT

The present invention relates to an illuminated indicia (4) formed from a material capable of absorbing light and transmitting light to an exposed edge. The material is preferably a fluorescent plastic material such as fluorescent acrylic sheets or molded members. The indicia (4) has a light absorbing section and a display section. The light absorbing section is exposed to a light source and the absorbed light is transmitted to the exposed edge (18) of the display section. The thickness of the exposed edge (18) of the display section is less than the length of the light absorbing section. Under typical indoor and outdoor lighting conditions, a constant passive illumination is created by the exposed edge of the display section. In a preferred embodiment the indicia is formed from material containing a light stimulating agent or additive. When the intensity of the light is sufficient, a halo effect may be achieved at the exposed edge.

### BACKGROUND OF THE INVENTION

1. Field of the Invention

This invention relates to devices to create illuminated indicia with distinctive illumination aesthetics of the indicia. The present invention has particular application to illuminated signs.

2. Description of the Prior Art

Traditionally illuminated indicia have been created by various means, including neon signs or remote lighting such as flood lighting or by backlighting.

There are several problems with neon signs. They can break down with partial failure while power is still on. You must use external coloring on the tube to achieve different colors in one system. They are not practical for small indicia. With the power source switched off, neon signs are virtually indecipherable. With neon signs, sharp corners on the indicia cannot be made. Neon signs are either “on” or “off”.

Similar problems exist with both remote lighting, floodlighting and backlit signs.

Other methods of displaying lighted indicia include the use of luminescent materials, whether fluorescent or phosphorescent, however an ultra-violet light source is required.

U.S. Pat. Nos. 4,711,044 and 4,767,477 describe a “neon look” lighting comprising a base panel made of a material that does not absorb ultraviolet light. A design is etched into a surface of the panel and a ribbon of liquid polyester film having fluorescent ultraviolet light pigments mixed therein is applied to the etched area. The panel is the mounted in a display area and backlit with an ultraviolet light source.

U.S. Pat. No. 5,232,388 describes signage that produces a visual effect of a glow by backlighting an image on a display panel.

U.S. Pat. No. 2,375,177 describes a method of decorating surfaces with luminescent materials. U.S. Pat. No. 5,162,160 provides a fluorescent screen made of light scattering material. U.S. Pat. No. 4,949,489 describes an edge-lit image display.

U.S. Pat. No. 5,536,558 describes a display constructed from fluorescent plastic sheet material to provide an ambient light capturing and intensifying light conduit. A substantially opaque reflective layer is formed on one side of the light conduit. A decorative layer is formed over the reflective layer and is selected to provide a desired sign decor. Grooves are formed in the light conduit through the reflective decorative coating in the pattern of the selected display. The grooves are formed to a depth to intercept light captured in the light conduit. The grooves provide angled surfaces that refract, capture and illuminate light out of the light conduit. Some light refracted out of the light conduit at the angled surfaces illuminates the selected grooves of the display. Grooves formed in the light conduit are of a shape to provide refraction of captured concentrated light within the light conduit and preferably substantially semicircular cross section to better simulate the effect of neon.

U.S. Pat. No. 5,009,019 describes a sign plate for an illuminated sign. The illuminated sign has an ultra-violet light source and the sign plate includes an opaque layer on one of its faces which layer is broken by zones corresponding to a configuration of text or figures to be communicated. The zones are covered with fluorescent material, and the surface of the fluorescent material facing the viewer and opposite the light source is covered with a light reflective layer.

U.S. Pat. No. 4,891,896 describes a simulated neon sign using pigmented coating applied to non-projecting regions on a sign panel to simulate the halo effect of a neon light.

U.S. Pat. No. 4,377,750 describes a passive display device that entraps light and emits light through reflectively coated notches, grooves or pigment layers on the surface of the display.

### SUMMARY OF THE INVENTION

It is an object of the invention to provide devices to create illuminated indicia formed from a material capable of absorbing light and transmitting it to an exposed edge.

It is a further object of the invention to provide devices to create illuminated indicia using passive illumination from artificial light or natural light.

It is a further object of the invention to provide devices to create illuminated indicia formed from a material containing a light stimulating agent or additive and capable of absorbing light and transmitting it to an exposed edge to form a halo effect and distinctive aesthetics of the indicia at the exposed edge.

Thus in accordance with the present invention there is provided an illuminated indicia formed from a material capable of absorbing light and transmitting light to an exposed edge. The material is preferably a fluorescent plastic material such as fluorescent acrylic sheets or molded members. The indicia has a light absorbing section and a display section. The light absorbing section is exposed to a light source and the absorbed light is transmitted to the exposed edge of the display section. The thickness of the exposed edge of the display section is less than the length of the light absorbing section. Under typical indoor and outdoor lighting conditions, a constant passive illumination is created by the exposed edge of the display section. In a preferred embodiment the indicia is formed from material containing a light stimulating agent or additive. When the intensity of the light is sufficient, a halo effect may be achieved at the exposed edge.

Further features of the invention will be described or will become apparent in the course of the following detailed description.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a perspective view of one embodiment of illuminated indicia according to the present invention.

FIG. 2 is a partial sectional view of the illuminated indicia of FIG. 1.

FIG. 3 is a front plan view of the illuminated indicia of FIGS. 1 and 2.

FIG. 4 is a cross section along line 2-2 of the illuminated indicia of FIG. 3.

FIG. 5 is a perspective view of a second embodiment of illuminated indicia according to the present invention.

FIG. 6 is a cross section along line 6-6 of the illuminated indicia of FIG. 5.

FIG. 7 is a perspective view of a third embodiment of illuminated indicia according to the present invention.

FIG. 8 is a cross section along line 8-8 of the illuminated indicia of FIG. 7.

FIG. 9 is a perspective view of another embodiment of illuminated indicia according to the present invention.

FIG. 10 is a cross section along line 10-10 of the illuminated indicia of FIG. 9. FIG. 11 is a perspective view of another embodiment of illuminated indicia according to the present invention.

FIG. 12 is a perspective view of another embodiment of illuminated indicia according to the present invention.

### DETAILED DESCRIPTION OF THE PREFERRED EMBODIMENTS

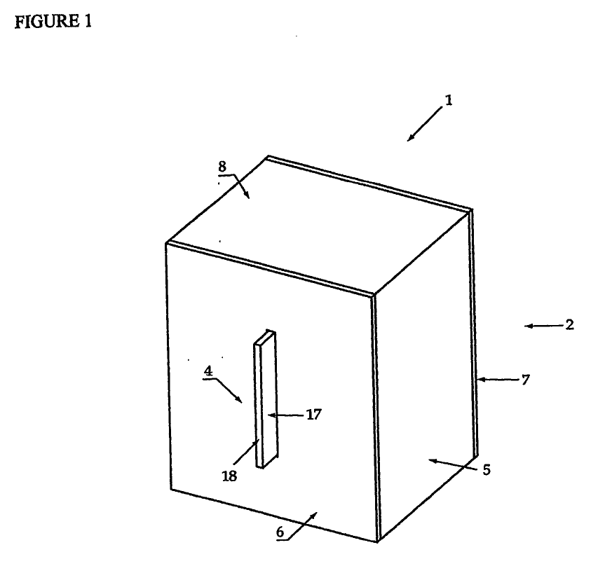

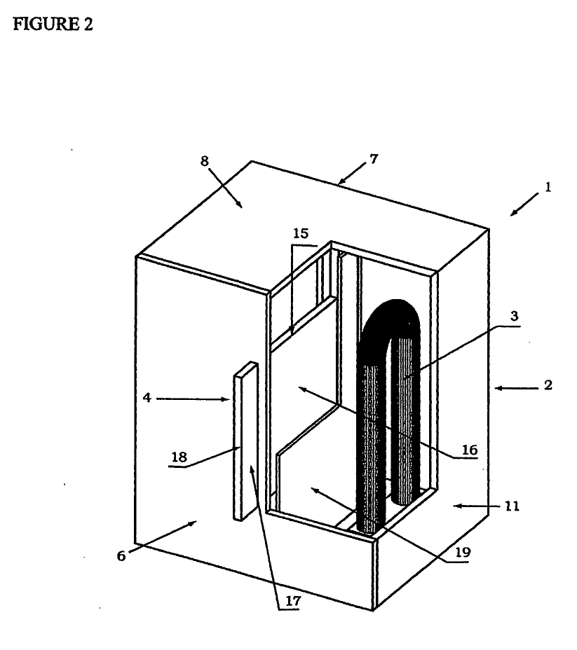

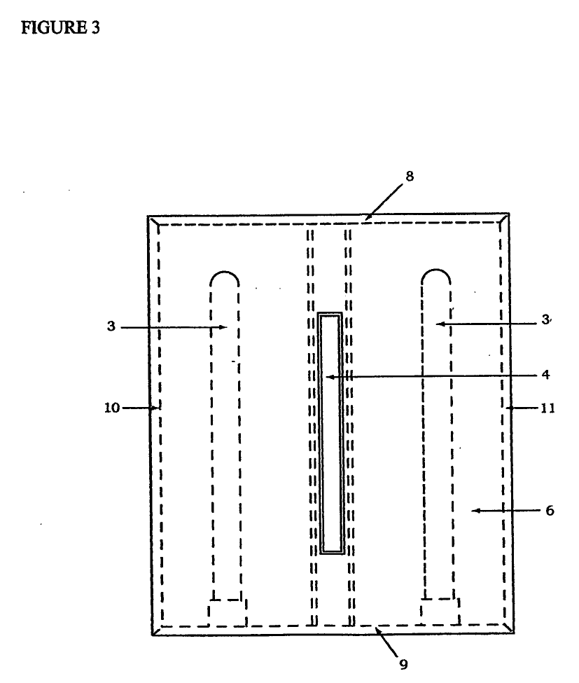

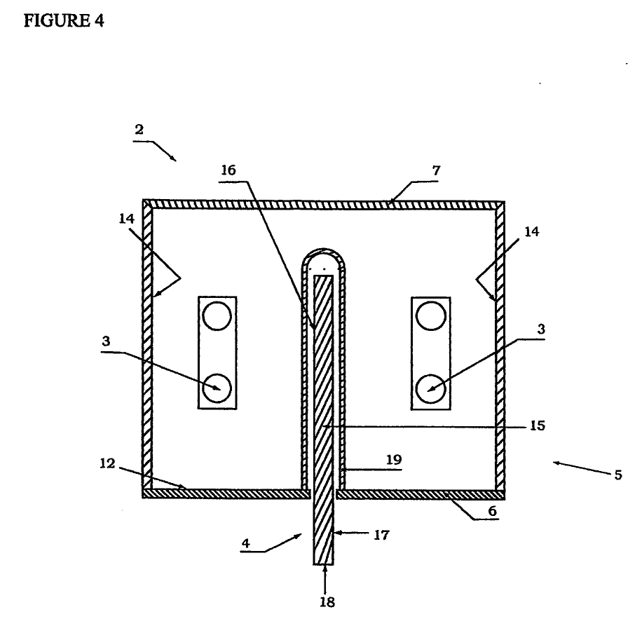

Referring to FIGS. 1 to 4, one embodiment of a device to create illuminated indicia according to the present invention is generally indicated at 1. The device comprises a light source 3 and indicia 4. The indicia 4 has a first section (light absorbing section) 16 exposed to the light source 3, a second section (display section) 17 that has an exposed remote edge 18 that forms the indicia being illuminated. The embodiment also includes means to focus the light from light source 3 on the first section 16 of the indicia so that the first section 16 absorbs light from light source 3 and transmits the light to the exposed remote edge 18 providing an illuminated indicia. In the embodiment illustrated in FIGS. 1 to 4 the means to focus the light is a chamber 2. The chamber 2, in the embodiment illustrated, is a rectangular box 5 having front 6, back 7, top 8, bottom 9 and opposite side 10, 11 panels. The front panel 6 is preferably made of an opaque material preferably with a reflective internal surface 12. When the front panel is opaque, its external surface may be selected to provide a background that contrasts with the indicia 4 so that it is more visible. The preferred material for front panel 6 is acrylic mirror. Other possible materials include stainless steel, chrome plated plastics such as ABS or chrome plated aluminum etc. The side panels 10, 11 are preferably made from an opaque plastic preferably with reflective internal surface 14 or any other material with similar qualities. The back panel 7, top panel 8 and bottom panel 9 are similarly made from an opaque plastic preferably with reflective internal surfaces or any other material with similar qualities.

The light source 3 in the embodiment shown comprises a full spectrum fluorescent light preferably with a UV protective shield. Other potential light sources include incandescent lamps preferably with UV protective shield, halogen lamps preferably with UV protective shield or any other visible light source. Alternatively the UV protective shield can be provided as a separate component such as a film around the light absorbing section of the indicia or eliminated altogether. Protecting the indicia from UV light extends the life of the indicia.

The indicia 4 in the embodiment shown represents the number one and is made from a material having the quality of absorbing light and transmitting the light (or a substantial portion thereof) to the remote exposed edge. In addition, in order to obtain a halo effect at the exposed edge 18, the indicia is formed from a material containing a light stimulating agent or additive. The light stimulating agent or additive is selected from the group consisting of fluorescent pigments, phosphorescent pigments and ultraviolet pigments In this embodiment the indicia is made from a flat sheet 15 of an fluorescent acrylic preferably Acrilite GPFL™ or Acrilite GP™ exotic edge color sheet, preferably the latter. While in the present embodiment, the indicia is formed from flat sheet 15 it can be virtually any shape provided the light can be absorbed and transmitted in a straight line to the exposed edge 18. The indicia can be formed from pieces of flat sheet 15 or molded to form the desired shape. In addition the individual indicia in a display can be made of different colored materials or multi colored material and multi parts, inserted at angles etc to create different visual effects. The flat sheet 15 is inserted into and through the front panel 6 of chamber 2. A first section 16 of flat sheet 15 projects into chamber 2 and absorbs light from light source 3 to form the light absorbing section. A second section 17 of flat sheet 15 that is projecting out of front panel 6 has an exposed remote edge 18 that forms the indicia being illuminated. Light is absorbed by the first section 16 and transmits the light to the exposed remote edge 18 providing an illuminated indicia. The thickness of the exposed remote edge 18 is less than the length or width of the light absorbing section 16. The illuminated indicia in this case is the numeral one and the illumination has a halo effect. The halo effect is enhanced, as front panel 6 is opaque. The brightness and transparency of the illumination will change with the intensity of the light source and the thickness of the exposed edge of the indicia where the light is projected.

In the embodiment shown the light source 3 is two compact fluorescent tubes with 5 watt power which together produces 230 lumens. A UV protective shield 19 is provided around the light absorbing section 16 of indicia 4. The rectangular box 5 is nominally 3.5 inches wide, 3.5 inches deep and 5.5 inches high. The total length of the indicia is 3.5 inches high, 3.5 inches deep or long and it is ⅛ inch thick. Approximately 2 ½ inches is located inside the box and about ⅞ inch is exposed outside the box. The surface of the first section 16 of the indicia inside the box (light absorbing section) is about 8.75 square inches. While nominal dimensions and shape are indicated for the embodiment illustrated, the present invention is not dependent on any particular size or shape of indicia.

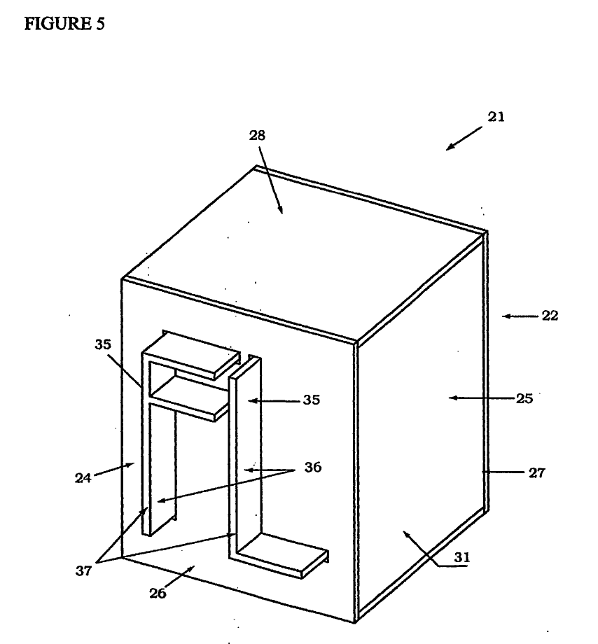

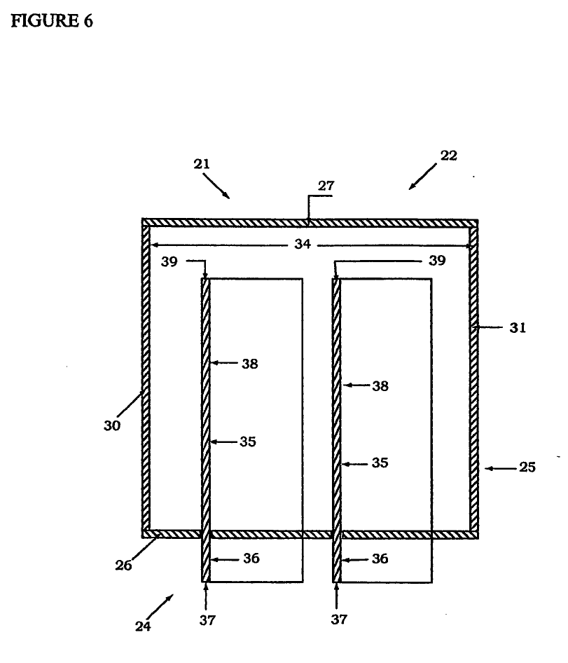

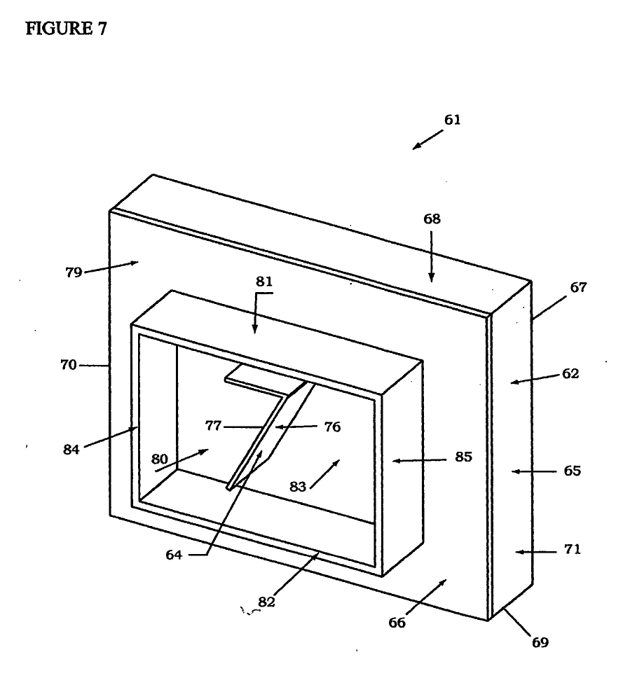

FIGS. 5 and 6 show a second embodiment of a device 21 to create an illuminated indicia according to the present invention using surrounding natural or artificial light. The device comprises a chamber 22 and indicia 24. The chamber 22, in the embodiment illustrated, is a rectangular box 25 having front 26, back 27, top 28, bottom 29 and opposite side 30, 31 panels. The front panel 26 and back panel 27 are made of a clear transparent material. The preferred material is transparent acrylic sheet with high transmitting properties. Other options include clear glass, clear polystyrene, clear polycarbonate or polyvinyl chloride. The front and back panels 26, 27 can be eliminated if the indicia 24 can be suspended in a stable position within chamber 22 for example with wires or the like. The side panels 30, 31 are optionally made from a material preferably with reflective internal surface 34 or any other material with similar qualities. The top panel 28 and bottom panel 29 are similarly made from an opaque material preferably with reflective internal surfaces or any other material with similar qualities. Suitable materials for the top, bottom and side panels 28, 29, 30, 31 are acrylic mirror, stainless steel, chrome-plated plastics such as ABS or chrome plated aluminum etc

The light source in the embodiment shown comprises light from the surrounding environment or alternatively can be provided by an external spot light such as a halogen lamp preferably with UV protective shield, incandescent lamps preferably with UV protective shield, or any other visible light source preferably with a UV protective shield.

The indicia 24 in the embodiment shown represents the letters F and L and is made from a material having the quality of absorbing light and projecting the light (or a substantial portion thereof) to the remote exposed edge. In this embodiment the indicia is made from flat sheets 35 of a fluorescent acrylic preferably Acrilite GPFL™ or Acrilite GP™ exotic edge color sheet, preferably the latter. The flat sheets 35 are inserted into and through the front panel 26 of chamber 22. A first section 36 of flat sheets 35 that are projecting out of front panel 26 have exposed remote edges 37 that form the indicia being illuminated. The second section 38 of flat sheets 35 project into chamber 22 and absorbs light from the environment and transmits the light to the exposed remote edges 37 providing an illuminated indicia. The light, either artificial or natural, enters from the front or back of the chamber. The available light in the chamber is absorbed by the surface of the indicia within the chamber. The greater the surface area, the greater amount of light is absorbed and consequently transmitted to the exposed edge. The proportion of the surface area of the light absorbing section 38 to that of the exposed edge 37 is important to creating the contrast from a passive light to a halo effect. The surface area of the exposed remote edge 37 is smaller than the surface area of the light absorbing section 38. This is typically accomplished by the thickness of the exposed edge 37 being smaller than the length or width of the indicia 24. Under typical indoor and outdoor lighting conditions, a constant passive illumination is created by the exposed edge 37 of the display section 36. When the intensity of the light is increased sufficiently, a halo effect may be achieved. As an option (not shown) in daylight, by applying reflective tape on the edges 39 of the sheets 35, other than the exposed edge 37 forming the indicia, the light is re-directed to the remote edge 37 with no tape and there is an increase in illumination.

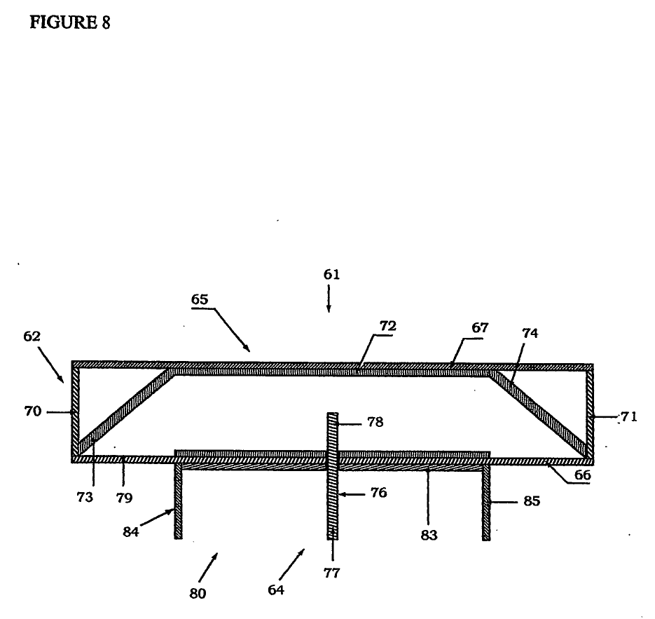

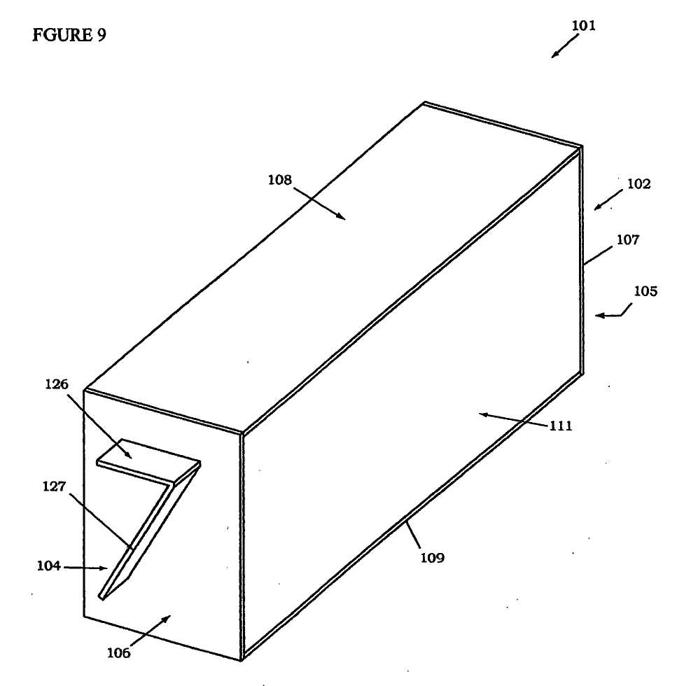

Referring to FIGS. 7 to 8, a third embodiment of a device to create an illuminated indicia according to the present invention is generally indicated at 61. In this embodiment the indicia is illuminated by light from the front of the indicia. The device consists of a chamber 62 and indicia 64. The chamber 62, in the embodiment illustrated, is a rectangular box 65 having front 66, back 67, top 68, bottom 69 and opposite side 70, 71 panels. The front panel 66 is made of any transparent material. The preferred material is transparent acrylic sheet with high transmitting properties. Other options include clear glass, clear polystyrene, clear polycarbonate or polyvinyl chloride. The back panel 67 is preferably is made from an opaque material preferably with a reflective internal surface 72 or any other material with similar qualities. Suitable materials for the back panel 67 are acrylic mirror, stainless steel, chrome-plated plastics such as ABS or chrome plated aluminum etc. The side panels 70, 71 are preferably made from any material that provide support for the device. The top panel 68 and bottom panel 69 are similarly made from any material that will provide support for the device.

As shown in FIG. 8, within chamber 62 are reflective panels 73, 74. In the embodiment shown the reflective panels 73 and 74 are made from a acrylic mirror, stainless steel, chrome plated plastics such as ABS or chrome plated aluminum etc. Panels 73 and 74 are arranged at 45° angle from the front panel 66 to direct light entering the chamber to indicia 64. In the preferred embodiment, but not shown in the drawing, additional reflective panels can be provided above and below indicia 64 to assist in directing light to the indicia.

The light source in the embodiment shown comprises light from the environment from the front of the chamber 62. Any “visible light” source either natural or artificial, in this case the preferred light source is daylight. An external spot light such as a halogen lamp preferably with UV protective shield, incandescent lamps preferably with UV protective shield, or any other visible light source preferably with a UV protective shield directed toward the front transparent panel can be used.

The indicia 64 in the embodiment shown represents the number seven and is made from a material having the quality of absorbing light and projecting the light (or a substantial portion thereof) to the remote exposed edge. In this embodiment the indicia is made from flat sheets 75 of a fluorescent acrylic preferably Acrilite GPFL™ or Acrilite GP™ exotic edge color sheet, preferably the latter. The flat sheets 75 are inserted into and through the front panel 66 of chamber 62. A first section 76 of flat sheets 75 that is projecting out of front panel 66 has an exposed remote edge 77 that forms the indicia being illuminated. The second section 78 of flat sheet 75 projects into chamber 62 and absorbs light from light directed from reflective panels 72, 73, 74 and transmits the light to the exposed remote edge 77 providing an illuminated indicia.

On the external surface 79 of front panel 66 and surrounding indicia 64 is an open enclosure 80 having top 81, bottom 82, back 83 and opposite sides 84, 85. The top 81, bottom 82, back 83 and opposite sides 84, 85 of enclosure 80 are made of any opaque material. Top 81, bottom 82, back 83 and opposite sides 84,85 are made of a dark opaque material such as ABS, PET or PVC. The open enclosure 80 creates a high contrast between the background of the enclosure 80 and the illuminated indicia.64. The distinctive aesthetic effects vary from a passive illumination to a halo effect indicia.

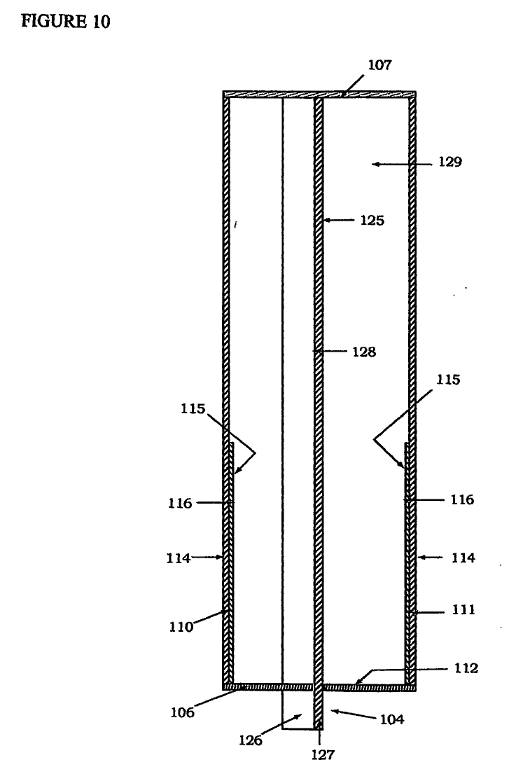

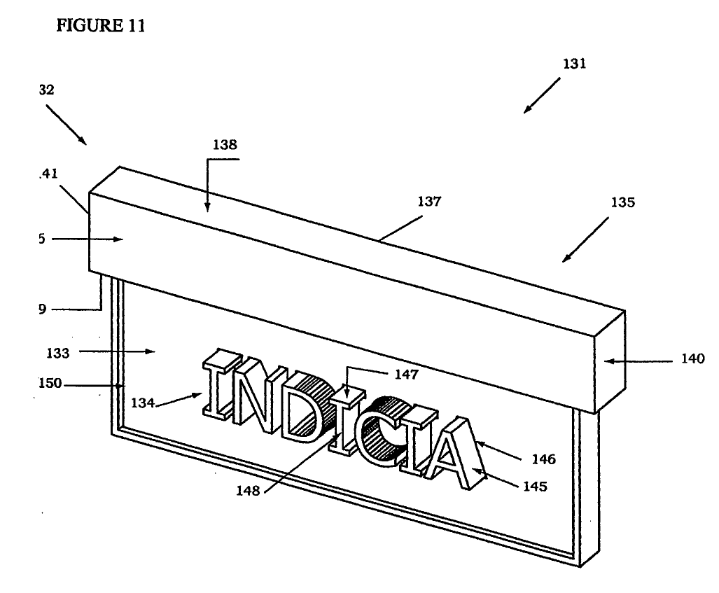

Referring to FIGS. 9 to 10, another embodiment of a device to create an illuminated indicia according to the present invention is generally indicated at 101. The device comprises a chamber 102 and indicia 104. The chamber 102, in the embodiment illustrated, is a rectangular box 105 having front 106, back 107, top 108, bottom 109 and opposite side 110, 111 panels. The front panel 106 is made of an opaque material preferably with reflective internal surface 112. The preferred materials for front panel 106 are acrylic mirror, stainless steel, chrome-plated plastics such as ABS or chrome plated aluminum etc. The back panel 107 is preferably made of a transparent material. The side panels 110, 111 are preferably made from a transparent material. The preferred material is transparent acrylic sheet with high transmitting properties. Other options include clear glass, clear polystyrene, clear polycarbonate or polyvinyl chloride. A portion 114 of side panels 110, 111 adjacent front panel 106 is adapted to provide a reflective internal surface 115. In the embodiment shown the reflective surface 115 is obtained by attaching sheets 116 made of reflective material such as acrylic mirror, stainless steel, chrome plated plastics such as ABS or chrome plated aluminum etc. The top panel 108 and bottom panel 109 are similarly made from a transparent material. The preferred material is transparent acrylic sheet with high transmitting properties. Other options include clear glass, clear polystyrene, clear polycarbonate or polyvinyl chloride. A portion of the top and bottom panels 108, 109 adjacent front panel 106 may be adapted to provide a reflective internal surface.

The light source in the embodiment shown comprises surrounding light from the environment. Any “visible light” source either natural or artificial, in this case the preferred light source is daylight. An external spot light such as a halogen lamp preferably with UV protective shield, incandescent lamps preferably with UV protective shield, or any other visible light source preferably with a UV protective shield directed toward the front transparent panel can be used.

The indicia 104 in the embodiment shown represents the number seven and is made from a material having the quality of absorbing light and projecting the light (or a substantial portion thereof) to the remote exposed edge. In this embodiment the indicia is made from a sheet 125 of a fluorescent acrylic preferably Acrilite GPFL™ or Acrilite GP™ exotic edge color sheet, preferably the latter. The sheet 125 is inserted into and through the front panel 106 of chamber 102. A first section 126 of sheet 125 that is projecting out of front panel 106 has an exposed remote edge 127 that forms the indicia being illuminated. The second section 128 of sheet 125 projects into the rear 129 of chamber 102 and absorbs light and transmits the light to the exposed remote edge 127 providing an illuminated indicia. The illuminated indicia in this case is the numeral seven and the illumination varies from passive illumination to a halo effect depending on the intensity of the light source.

In FIG. 11 another embodiment of a device to create an illuminated indicia according to the present invention is generally indicated at 131. The device comprises a light source 132, indicia support member 133 and indicia 134. The light source 132, in the embodiment illustrated, is a rectangular box 135 having front 136, back 137, top 138, bottom 139 and opposite side 140, 141 panels. The front 136, back 137, top 138, bottom 139 and opposite side 140, 141 panels are preferably made of an opaque material preferably with reflective internal surface. A light such as a halogen lamp preferably with UV protective shield, incandescent lamp preferably with UV protective shield, or any other visible light source preferably with a UV protective shield is located within the box 135. The preferred materials for front 136, back 137, top 138, bottom 139 and opposite side 140, 141 panels of box 135 are acrylic mirror, stainless steel, chrome-plated plastics such as ABS or chrome plated aluminum etc. Indicia support member 133, in the embodiment illustrated is a rectangular sheet or panel made from a material having the quality of absorbing light and projecting the light (or a substantial portion thereof) to the remote exposed edge. The preferred material is transparent acrylic sheet with high transmitting properties with or without fluorescent additives. Other options are Acrilite GPFL™ or Acrilite GP™ Exotic edge color sheets. A portion of indicia support member 133, is adapted to be inserted into the box 135.

The indicia 134 in the embodiment shown represents the letters that spell the word “INDICIA” and is made from a material having the quality of absorbing light and projecting the light (or a substantial portion thereof) to the remote exposed edge. In the embodiment shown, indicia support member 133 is a panel formed from a sheet of ½″ thick clear acrylic. In this embodiment the indicia 134 is made from a pieces 145 of a fluorescent acrylic, preferably Acrilite GPFL™ or Acrilite GP™ exotic edge color sheet, preferably the latter, to form the individual letters of the word “INDICIA”. The letters 145 are inserted into slots 146 in panel 133. Slots 146 are sized and shaped to match the size and shape of the letters 145 making up indicia 134. A first section 147 of letters 145 projects out of panel 133 and has an exposed remote edge 148 that forms the indicia being illuminated. The second section of letters 145 (not visible) projects into the slots 146 in panel 133. Light absorbed by the panel 133 is directed to its edges, including the edges around the slot(s) 146 through which the letters 145 are inserted. The light is then absorbed by indicia 134 and transmitted to the exposed remote edge 148 providing an illuminated indicia In order to prevent illumination at the outer edges 150 of the panel 133 and to redirect light to the indicia, it is preferred that the outer edges of panel 133 be covered by reflective tape or some similar material.

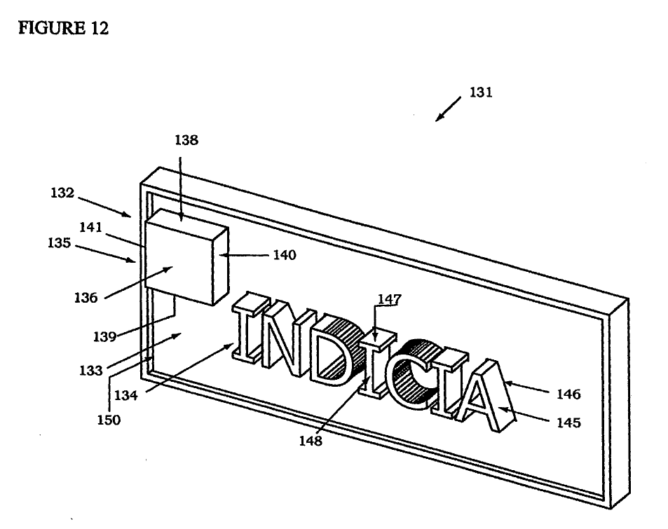

In FIG. 12, a variation of the light box of FIG. 11 is illustrated. In this embodiment the light source 132 is a box 135′ that is relatively small and only a small portion of panel 133 is inserted into the box 135′. This results in brighter illumination. It is possible to eliminate the box 135′ entirely and rely solely on panel 133 to absorb surrounding light The illumination is enhanced if reflective tape or some similar material is provided on the exposed edges of panel 133. If additional indicia are attached to indicia 134, light is absorbed by indicia 134 and will be transmitted to the additional indicia which will absorb and transmit the light to its exposed remote edge providing additional illuminated indicia. In this way the light produced at the edge of the indicia, can be used as the light source for a different indicia and so on.

In the different embodiments illustrated the indicia is made of one or more pieces of the same colour of material, which material has the quality of absorbing light and projecting the light (or a substantial portion thereof) to its exposed edges. If the indicia 4, in FIGS. 1 and 2, is made of two different colored pieces of material having the quality of absorbing light and projecting the light (or a substantial portion thereof) to the remote exposed edge, a different illumination effect is obtained. One color (red as an example) forms the first section 16 that projects into the chamber 2 and a part of second section 17 that is projecting out of front panel 6. The remaining portion of the second section 17 is formed from the second color (yellow as an example) along the exposed remote edge 18 that forms the indicia being illuminated.

Where the yellow portion of indicia located outside the chamber and red portion of the indicia inside the box are equal or different sizes and light is exposed to the red portion the following illumination results:
a—At the point where the two portions are connected the red color is brighter and overcomes the yellow.
b—Where the red and yellow portions are the same size, if the red colored portion is exposed to intense light, even when the box is eliminated, and the light source is located closer to the red portion, the edge of the yellow portion will be illuminated in an orange color.
c—The main surface of the yellow portion which is located outside the box will not change in color.

Where the red and yellow portions have different sizes, when the light is “off”, at the point where they are connected the color with the larger size looks brighter. This result is achieved because the larger color portion acts as the light collecting device for the smaller colored portion. If their sizes are equal the colors at the point where they are connected are unchanged assuming the two pieces have the same saturation in color and transparency.

Based on these different results several different effects can be achieved.
First: Referring to the above example, it is possible to achieve a color illumination at the edge of the indicia that differs from the main body. In this case orange illumination at the edge where the main body remains yellow, which is a great effect.
Second: If we change the yellow color in the example above with clear colored piece of equal or different size to the red portion, when the light is on red illumination will occur at the edge of the clear portion and when the light is interrupted (off) the clear portion becomes invisible.
Third: If the light chamber is eliminated and the red color is proportionally longer than the yellow color, using the surrounding or environment light will produce orange illumination at the edge of the yellow colored portion. The red colored portion performs as a device to collect the light from the environment and the yellow portion performs as indicia for the illumination.
Fourth: If the red portion is located in a similar colored environment, such as a bottle of red transparent liquid, the red portion acts as the light collecting device and is invisible.

While the examples referred to use two different colors of material, the indicia can be made from more than two colors to achieve a wide variety of illumination effects.

The present invention has a wide variety of applications from: logos, buttons in electronic instruments, house numbers, displays, exhibits, indoor and out door signs where sufficient lighting is provided or any other indoor and outdoor visual effect device or architectural use. Having illustrated and described preferred embodiments of the invention and certain possible modifications thereto, it should be apparent to those of ordinary skill in the art that the invention permits of further modification in arrangement and detail. All such modifications are covered by the scope of the invention.

1. An illuminated indicia formed from a material capable of absorbing light and transmitting light to an exposed edge, said indicia has a light absorbing section and a display section, said light absorbing section is exposed to a light source and the absorbed light is transmitted to the exposed edge of the display section of said indicia wherein the thickness of the exposed edge is smaller than the length or width of the indicia.

2. An illuminated indicia according to claim 1 wherein under indoor and outdoor lighting conditions, a constant passive illumination is created by the exposed edge of the display section.

3. An illuminated indicia according to claim 1 wherein the intensity of the light causes a halo effect is achieved at the exposed edge of the display section.

4. A device to create an illuminated indicia comprising a light source and an indicia said indicia has a first section exposed to the light source and a section with an exposed remote edge that forms the indicia being illuminated and means to focus the light from said light source on the first section of the indicia so that the first section absorbs light from said light source and transmits the light to the exposed remote edge providing an illuminated indicia.

5. A device to create an illuminated indicia according to claim 4 wherein the means to focus the light is a chamber.

6. A device to create an illuminated indicia according to claim 5 wherein the chamber has front, back, top, bottom and opposite side panels, wherein said front, back, top, bottom and side panels are made of an opaque material with a reflective internal surface and said light source is provided in said light chamber.

7. A device to create an illuminated indicia according to claim 5 wherein the chamber has front, back, top, bottom and opposite side panels, wherein said back, top, bottom and side panels are made of an transparent material, said front panel is made of an opaque material and said light source is from the surrounding environment.

8. A device to create an illuminated indicia according to claim 5 wherein the chamber has front, back, top, bottom and opposite side panels, wherein said front and back panels are made of a clear transparent material and said top, bottom and side panels are made of an opaque material with a reflective internal surface and said light source is provided from the surrounding environment.

9. A device to create an illuminated indicia according to claim 5 wherein the chamber has front, back, top, bottom and opposite side panels, wherein said front panel is made from a transparent material, said back panel is made of an opaque material with a reflective internal surface, wherein reflective panels are provided within said chamber at a 45 degree angle from the front panel to direct light entering from the front of the chamber to the indicia.

10. A device to create an illuminated indicia according to claim 4 wherein the means to focus the light from said light source is an indicia support member made from a material capable of absorbing light and transmitting light to an exposed edge and wherein said indicia are inserted into slots in said indicia support member, said slots shaped and sized to match the size and shape of the cross section of said indicia.

11. A device to create an illuminated indicia according to claim 10 wherein the light source is a box having front, back, top, bottom and opposite side panels having a light located within said box and a portion of indicia support member being adapted to be inserted into said box.

12. A device to create an illuminated indicia according to claim 11 wherein the front, back, top, bottom and opposite side panels of said box are made of an opaque material with a reflective internal surface.

13. A device to create an illuminated indicia according to claim 12 wherein said indicia support member is made of Acrilite GPFL™ or Acrilite GP™ exotic edge color sheet.

14. A device to create an illuminated indicia according to claim 12 wherein an additional indicia made from a material capable of absorbing light and transmitting light to an exposed edge is inserted into slots in the indicia attached to said indicia support member, said slots shaped and sized to match the size and shape of the cross section of said additional indicia.

15. A device to create an illuminated indicia according to claim 4 wherein said indicia are made from two or more different colors of a material capable of absorbing light and transmitting light to an exposed edge.

16. An illuminated indicia formed from a material capable of absorbing light and transmitting light to an exposed edge according to claim 1 wherein said indicia is made from two or more different colors of a material and has a light absorbing section and a display section.

17. A device to create an illuminated indicia according to claim 13 wherein an additional indicia made from a material capable of absorbing light and transmitting light to an exposed edge is inserted into slots in the indicia attached to said indicia support member, said slots shaped and sized to match the size and shape of the cross section of said additional indicia.
